(19) United States
(12) Patent Application Publication
(10) Pub. No.: US 2013/0275334 A1
(43) Pub. Date: Oct. 17, 2013

(54) SYSTEM AND METHOD FOR MANAGING ASSET PORTFOLIOS

(71) Applicants: Kristine Louise Andersen, Santa Monica, CA (US); Patrick Kenneth Glenn, Torrance, CA (US)

(72) Inventors: Kristine Louise Andersen, Santa Monica, CA (US); Patrick Kenneth Glenn, Torrance, CA (US)

(21) Appl. No.: 13/861,328

(22) Filed: Apr. 11, 2013

Related U.S. Application Data
(60) Provisional application No. 61/623,070, filed on Apr. 12, 2012.
(60) Provisional application No. 61/770,916, filed on Feb. 28, 2013.

(51) Int. Cl. G06Q 40/06

(52) U.S. Cl. CPC G06Q 40/06
USPC 705/36 R

(57) ABSTRACT

In exemplary embodiments of a computer implemented method, system and computer program for managing asset portfolios, asset allocation results conventionally dictated by Modern Portfolio Theory are modified through implementation of at least a market timing enhancement which signals when an investor should exit individual declining investment portfolio components. By optimizing an oscillator averaging period, computing an oscillator time history and optimizing long and short margin percentages of each of a defined portfolio of investment components, a modified time history of total return for each component is calculated. After inputting the modified time histories into a Classic Modern Portfolio Theory algorithm, allocations are altered based in the current value of the oscillator.

### RELATED APPLICATIONS

This application claims the benefit of U.S. Provisional Application No. 61/623,070 filed Apr. 12, 2012, and U.S. Provisional Application No. 61/770,916 filed Feb. 28, 2013, the contents of each of which are incorporated by this reference in their entirety for all purposes as if fully set forth herein.

### TECHNICAL FIELD

The present invention relates generally to systems, methods and computer programs for managing investment portfolios in a manner which seeks to maximize return on investment while minimizing investment risk.

### BACKGROUND

Global and domestic debt concerns are making economic markets extremely volatile and investors are scared. After being beaten up by the bursting of the dot-com bubble in 2000 and the sub-prime mortgage crisis in 2007, investors are justifiably reticent about placing funds into companies that may not be around in a couple of years let alone during their lifetimes, and many are fearful of losing their portfolios entirely.

Investors and fund managers are facing complex and confusing economic information and are at a loss as to which investment classes they should be buying or selling. They are especially gun-shy following the severe corrections in 2000 and 2007 when many professionally managed and personally managed portfolios lost 50% or more of their value. They ask the question of which asset classes make sense in today's markets—a question that can be partially answered by the mathematical approach of Modern Portfolio Theory (MPT). But the larger question of when to buy into or sell out of those asset classes is an answer that MPT by design cannot adequately address. During severe market corrections, MPT is very slow to respond to a rapidly changing market environment—a situation that can lead to serious portfolio loss.

Many wealth managers still design portfolios built upon the concepts of MPT. Although MPT has revolutionized portfolio management, it is not without its limitations. One of the precepts of MPT is that portfolios must always have funds distributed among the asset classes per the recommended allocation. In good times or in bad, one is almost never out of the market of high performing but risky assets. It is this concept that can lead to major portfolio loss during steep market corrections—losses that can take many years, even decades, to recover.

Realizing the risk of loss during downturns, many portfolio managers have sought to downplay the MPT approach by offering their own managed services. It seems that each such manager has his or her own approach towards risk management and, typically, the approach is labeled as “proprietary” making it opaque to investors as to how or why their funds are being distributed. Such subjectivity on the part of the fund manager can be eliminated by following a completely quantitative approach.

What is needed are improved systems, methods and computer programs which efficiently enable a user, such as a professional portfolio manager or individual investor, to conveniently and significantly improve the return on their investments compared to what the MPT model provides, in a transparent manner and while simultaneously reducing the risk of loss.

### SUMMARY

Certain deficiencies of the prior art may be overcome by the provision of one or more embodiments of a system, method or computer program configured to judiciously apply optimized market-timing to Modern Portfolio Theory (MTP). Such embodiments may not only solve the problem of which asset classes to hold and in what proportion, they may also direct the fund manager as to exactly when to exit an asset class entirely and when to jump back in. Historical back-testing over all time periods since 1928 show that preferred embodiments of the invention, which at least in part incorporate applicants' novel timing-modified MPT approach (which may also be referred to herein as “MMPT”), not only improve upon the expected return over the classic MPT approach, but also greatly minimize portfolio risk arising from sharp draw-downs especially during times of severe market stress.

Preferred embodiments may apply a timing oscillator separately to each asset class. Typically, the oscillator is only applied to equity asset classes such as stocks as opposed to those that have fixed returns, such as bonds. At least once each period (e.g., once per month) when new total return data for each asset class is received, the oscillator for each asset class is optimized and computed. If its value is positive, the funds computed by MPT are allocated to that respective asset class. If the value of the oscillator turns negative, the funds that MPT would normally allocate to that asset class may either be placed in the safety of a risk-free vehicle such as Short-Term Treasury Bills or Money Market Funds, or any other second allocation alternative of the respective strategy pair.

The present invention, at least in part, provides market timing enhanced system, method and computer program to signal when the investor should completely exit individual declining investment portfolio components. Classic Modern Portfolio Theory would keep the investor invested and exposed to continued risk and loss. The addition of a market timing system to the asset allocation process provides a timely exit to declining investment components, thus preserving portfolio value. The addition of a market timing enhancement improves both portfolio returns and lowers portfolio risk. An embodiment or component of the present invention is portfolio management software for use by individual investors as well as professional portfolio managers and investment brokerage houses. Other software products applied to the fields of insurance, process control, search engine optimization, social psychology, and information retrieval are also envisioned.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1a depicts an example flow diagram of a computer-implemented method, in accordance with example embodiments;

FIG. 1b depicts an illustrative operating environment that may be used to implement various aspects of the disclosure, in accordance with example embodiments;

FIG. 2 illustrates an example flow diagram of a system process overview for facilitating management of an asset portfolio in accordance with example embodiments;

FIG. 3 illustrates an example flow diagram of a sub-method for computing the market timing modified time histories in accordance with example embodiments;

FIG. 4 illustrates an example flow diagram of a sub-method for computing time values in accordance with example embodiments;

FIG. 5 illustrates an example flow diagram of a sub-method for optimizing oscillator averaging periods and computing best long and short margin percentages in accordance with example embodiments;

FIG. 6 illustrates an example flow diagram of a sub-method continuing from the portion of the diagram of FIG. 5 directed to computing the best averaging period in accordance with example embodiments;

FIG. 7 illustrates an example flow diagram of a sub-method continuing from the portion of the diagram of FIG. 5 directed to computing the best long or best short margin percentages in accordance with example embodiments;

FIG. 8 illustrates an example chart comparing returns for a classically constructed modern portfolio theory (MPT) portfolio, the S&P 500, and a corresponding portfolio managed in accordance with example embodiments of the present invention for a period from 1928 to present;

FIG. 9 illustrates an example chart containing comparative return data similar to that of FIG. 8, but over the specific time frame between January 1965 through December 1974;

FIG. 10 illustrates an example chart containing S&P 500 index performance from the year 2000 through the present (February 2013), illustrating the recent market turbulence;

FIG. 11 illustrates an example chart containing comparative return data similar to that of FIG. 8, but over the specific time frame from the year 2000 to present;

FIG. 12 illustrates an example chart containing comparative return data similar to that of FIG. 8, but over the specific time frame from September 2000 through November 2002, which may otherwise be referred to as the period of the “dot-com bust”;

FIG. 13 illustrates a table listing annualized total returns of all asset classes during the dot-com bust;

FIG. 14 illustrates a table listing classic MPT allocations during the dot-com bust for a targeted 10% compounded annual return (September 2000 through November 2002);

FIG. 15 illustrates a table listing allocation results presented in accordance with example embodiments of the present invention for the same period and return type (i.e. target) as that of FIG. 14;

FIG. 16 illustrates an example chart showing historical total return from small-cap stocks for the period from 2000 through 2003;

FIG. 17 illustrates an example chart showing historical total return from large-cap stocks for the period from 2000 through 2003;

FIG. 18 illustrates an example chart showing historical total return derived from the S&P 500 (large company stocks) for the period from late 2007 to early 2009, which may otherwise be referred to herein as the period of the “sub-prime mortgage crisis”;

FIG. 19 illustrates an example chart showing historical total return derived from small cap stocks for the same period as that of FIG. 18;

FIG. 20 illustrates a table listing annualized total returns of all asset classes during the sub-prime mortgage crisis;

FIG. 21 illustrates a table listing classic MPT allocations during the sub-prime mortgage crisis for a targeted 10% compounded annual return for the period from October 2007 through March 2009;

FIG. 22 illustrates a table listing allocation results presented in accordance with example embodiments of the present invention for the same period and return type (i.e. target) as that of FIG. 21; and

FIG. 23 illustrates an example chart comparing returns for a classically constructed MPT allocation portfolio, the S&P 500, and a corresponding portfolio managed and allocated in accordance with example embodiments of the present invention for the period of the sub-prime mortgage crisis.

### DETAILED DESCRIPTION OF THE PREFERRED EMBODIMENTS

Referring now to the drawings, like reference numerals designate identical or corresponding features throughout the several views.

Certain preferred embodiments in accordance with the present invention involve, at least in part, a real world technical implementation of a modification to classic Modern Portfolio Theory (MPT). Such modification may preferably introduce a market timing element to the traditional asset allocation buy, hold, and reallocate methodology. The inability of MPT to react quickly to declining markets is a recognized problem that calls for a solution based on a market timing enhancement. The intrinsic nature of classic MPT subjects the investor to losses during periods of market decline as well as increased portfolio risk. The addition of a market timing system to the asset allocation process provides a timely exit to declining investment components thus preserving portfolio value. The result is both improved portfolio returns as well as lower portfolio risk.

Market timing may preferably be determined through the implementation of a technical oscillator with averaging periods that are optimized separately for each asset class. Instead of maintaining the classic recommended allocations, asset classes can be exited completely when the oscillator for those classes turns negative with the funds being redirected to a safe asset class such as, for example, U.S. Treasury Bills. An asset class may be reinstated when the value of the oscillator for that class changes back from negative to positive. Certain real-world methods and systems that incorporate this process are presently embodied in, or operate using, a software product called the Portfolio Preserver® (portfoliopreserver.com.)

In embodiments, the process may begin with a time history of monthly total return data for each candidate asset class under consideration. For the nine traditional asset classes mentioned here, monthly total return data dating back to 1928 may preferably be used.

In embodiments, the aforementioned procedure of exiting an asset class and placing the funds into a risk-free asset class such as Treasury bills may preferably be referred to as the Long/T-Bills strategy. What this means is that when the timing oscillator is positive, the strategy employs the classic MPT approach of being invested or “Long” that asset class according to the MPT recommended allocation. Conversely, when the oscillator turns negative the allocation may preferably be instead placed in the safety of T-Bills (or another substantially risk-free instrument such as an insured money market).

In addition to this simple timely exiting of asset class allocations, other strategies (or what may be otherwise referred to herein as “strategy pairs”) are also available, including:
“Long/Long” is the classic MPT approach (meaning that timing is not used).
“Long/T-Bills” is the strategy described above, i.e., when the timing oscillator is positive for an asset class, funds are allocated to it; when the oscillator turns negative, those funds are removed from it and placed into T-bills or a safe cash-equivalent.
“Long/Short” is the classic MPT allocation when the oscillator is positive and short that asset class when it is negative.
“Long on Margin/T-Bills” is the same strategy as Long/T-Bills but with the use of margin.
“Long on Margin/Short on Margin” is the same as Long/Short but with the use of margin on both sides.
“T-Bills/Short” is a bearish strategy opposite Long/T-bills.
“T-Bills/Short on Margin” is an ultra-bearish strategy opposite Long on Margin/T-Bills.

One exemplary embodiment of a method in accordance with the present invention may be configured to facilitate performance of the following summarized investment approach:

Input Parameter Definition
Select overall portfolio required annual return, whether arithmetic or compound average.
Decide which of the above strategies (strategy pairs) to apply for each asset class (e.g., investment component). Optionally, this procedure can be conducted for every combination of strategy pair and investment component. The combination which produces the lowest overall portfolio risk while simultaneously achieving at least the desired (e.g., selected) overall portfolio return can then be used.
Select a market-timing oscillator. Although many oscillators are available (See the Appendix), we have found that the Commodity Channel Index (CCI) works very well with a diversity of asset classes.
Define other model parameters such as margin considerations, transaction and borrowing costs, etc.

Calculation of Asset Class Allocations (Steps 4-8)
Optimize the oscillator averaging period for each investment component or asset class. Once this is determined, the oscillator time history for each asset class can be computed.
Optimize the long and short margin percentages for each asset class for any strategy that requires these values.
Calculate the market-timing modified time histories of total return for each asset class. These are the historical performance results of using the left half of the strategy when the contemporaneous value of the oscillator is positive and the right half when it is negative.
Process the modified time histories through the algorithms of classic MPT to produce the unstrategized allocations.
Use the current sign of the oscillator to determine which side of the strategy pair to use. If the oscillator is positive, apply the left half of the strategy pair (e.g., long or in cash) and if it's negative, apply the right half of the strategy pair (e.g., short or in cash).

The above method may be repeated each month or as often as portfolio rebalancing is performed.

Now we turn to the mathematics of what may herein be termed Modified Modern Portfolio Theory (MMPT). In preferred embodiments, MMPT is substantially Modern Portfolio Theory (MPT) with an enhancement of market timing to address the criticism of MPT that it does not favor upside risk over downside risk. That is, MMPT considers equally bad excess positive returns over excess losses. In MPT, the investor is subjected to potential prolonged losses in declining asset classes until the long term data is finally able to “catch up” and reduce exposure. It can take a long time before the classic mathematics of MPT can respond and finally capitulate and provide an exit point from a losing investment. With MMPT, this is not the case. Declining asset classes are spotted quickly thus preserving portfolio value during market corrections.

We begin with a review of the portfolio problem, which is a minimization procedure to find that portfolio allocation with the lowest risk given the constraint of simultaneously producing a specified minimum overall long term arithmetic average target return. Risk is defined as the variation in overall portfolio return from that defined minimum. That is, we want to achieve our required goal but also stay as close to it as possible with minimum fluctuations.

Given a fixed sum of money, let F represent the total investment funds to be allocated among n different investment alternatives with known time histories of total returns. (Note: All of these time histories must start on the same date.) Let L be the desired minimum return to be achieved by the portfolio. Let xᵢ be the amount of funds allocated to investment i and let xᵢₖ denote the return per dollar from investment i during the kth time period in the past. Let p be the total number of historical time periods of data. If the future behaves like the average of the past (one of the tenets of MPT) then the expected return per dollar, from each investment class i is:

$${E}_{i} = \frac{1}{p} {\sum }_{k = 1}^{p} {x}_{ik}$$

and the expected return from all investments combined is:

E=E₁x₁+E₂x₂+ . . . +Eₙxₙ

Choose the quantity z as a measure of the total variability of future payments (e.g., risk):

$$z = \frac{1}{p} {\sum }_{k = 1}^{p} {( {x}_{1 k} {x}_{1} + {x}_{2 k} {x}_{2} + … + {x}_{nk} {x}_{n} - E )}^{2}$$

which reduces to:

$$z = {\sum }_{i = 1}^{n} {\sum }_{j = 1}^{n} {σ}_{ij}^{2} {x}_{i} {x}_{j}$$

where σᵢⱼ² are the covariances given by:

$${σ}_{ij}^{2} = \frac{1}{p} {\sum }_{k = 1}^{p} ( {x}_{ik} - {E}_{i} ) ( {x}_{jk} - {E}_{j} )$$

The function to be minimized is therefore:

$$z = {\sum }_{i = 1}^{n} {\sum }_{j = 1}^{n} {σ}_{ij}^{2} {x}_{i} {x}_{j}$$

subject to the constraints:

x₁+x₂+ . . . +xₙ=F

E₁x₁+E₂x₂+ . . . +Eₙxₙ≧L

with all variables non-negative.

This is solved through the use of quadratic programming. Applying Kuhn-Tucker conditions to the program and using the method of Frank and Wolfe provides an optimum result. The preceding mathematical analysis is directed to an arithmetic average, and is conventionally known. The corresponding process for calculating a geometric average is also conventionally known.

We now examine the application of an oscillator to the time history data for each investment class. In particular uses of embodiments, the value of the oscillator determines if an investment is to be held according to the allocation calculated by MPT or is instead entirely shifted to a designated safe asset class (T-bills). In more general application, the value of the oscillator determines if the left half or the right half of the strategy pair is to be used for that investment component.

Popular oscillators used to indicate overbought/oversold conditions are the Commodity Channel Index (CCI), the Moving Average Convergence/Divergence (MACD), and the Rate of Change (ROC). Of these three, extensive back-testing overall market conditions has shown that the CCI is the most accurate in terms of timing and yields the best results in terms of obtaining the desired portfolio return at the minimum amount of risk.

One of the key advantages of MMPT, particularly where strategy pairs such as long/T-bills are applied, is the ability to substitute the returns obtained by an investment or asset class for those returns achieved by the safe asset class when the oscillator has signaled a shift away from that asset class. In this way the time history for an investment as presented for evaluation is a combination of the unmodified asset class returns and those returns for the safe asset class. When the oscillator is negative those values in the time history of returns for that asset class are instead the time history values for the safe asset class. When the oscillator is positive the values are the values achieved by the asset class.

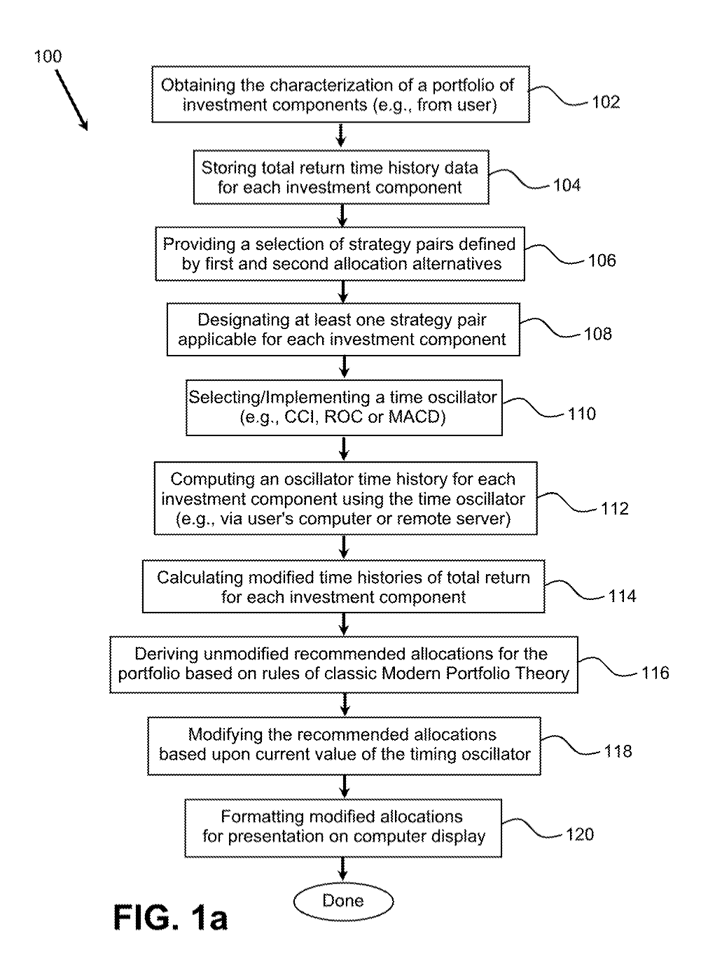

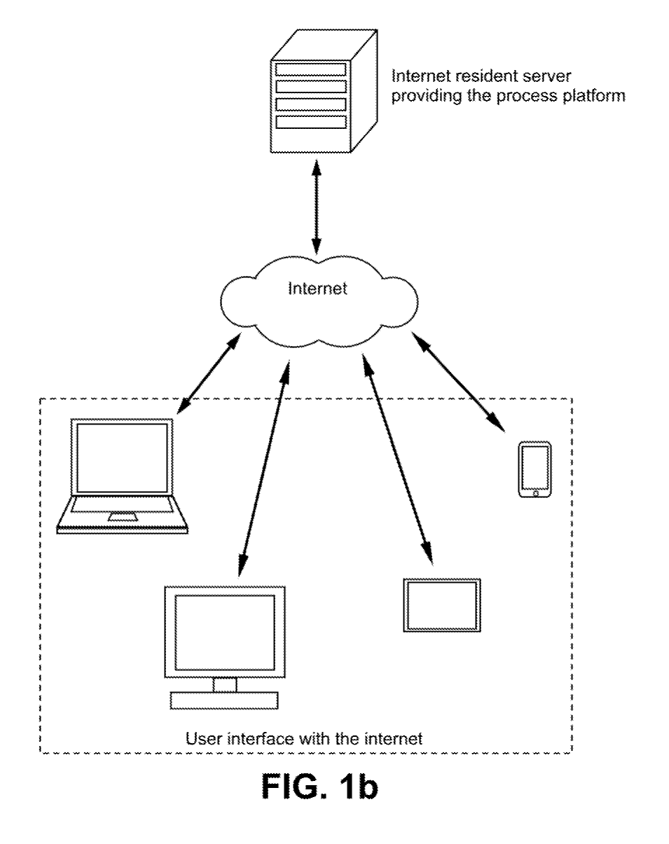

According to certain embodiments of the present invention, a process of enhancing market timing is performed, at least in part, on an electronic computing device having a memory, at least one processor, input/output devices, and a display (see, for example, FIG. 1b).

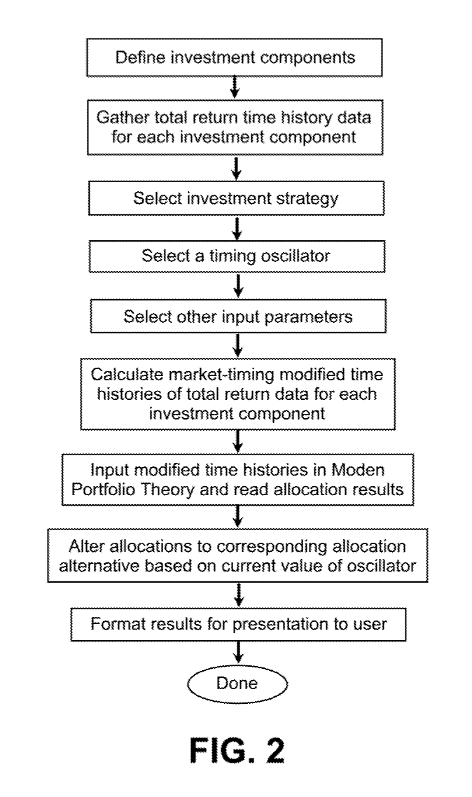

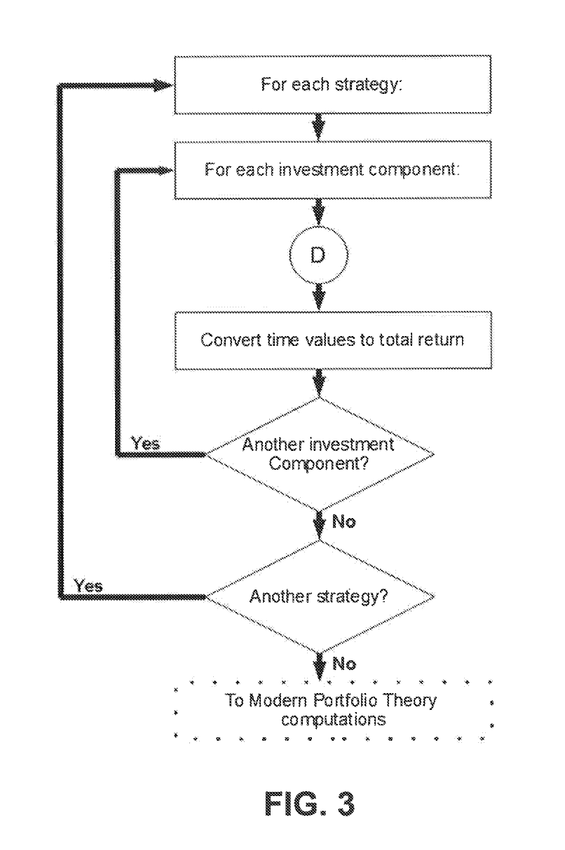

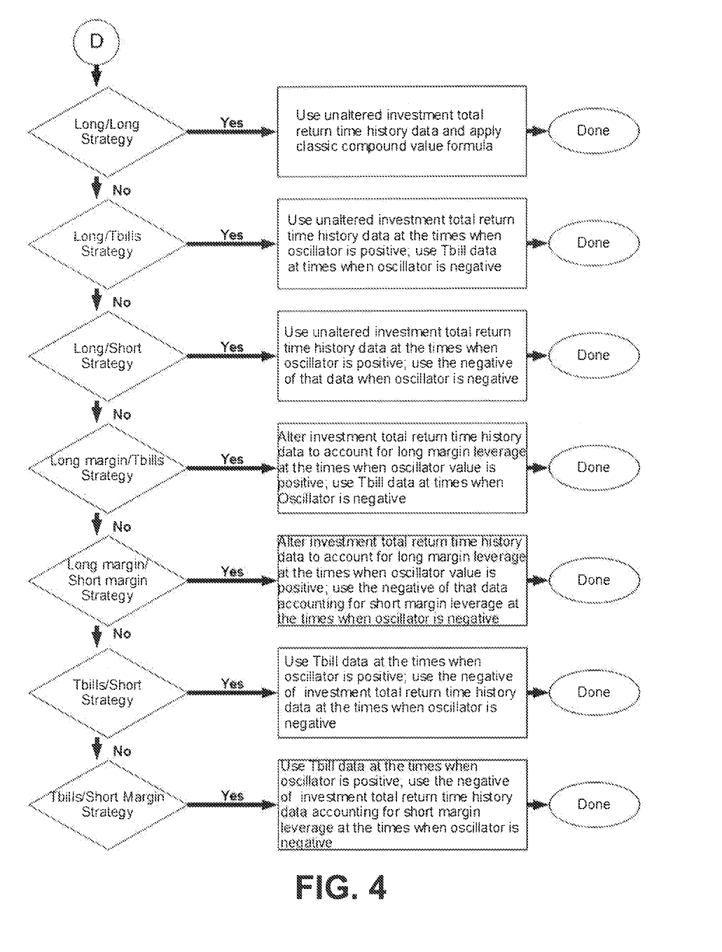

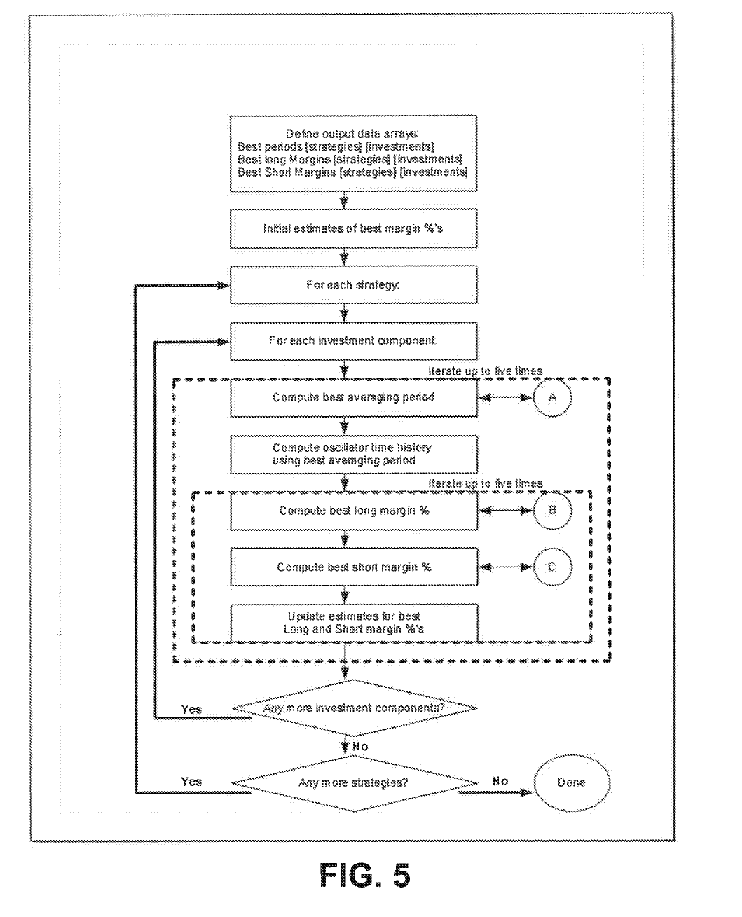

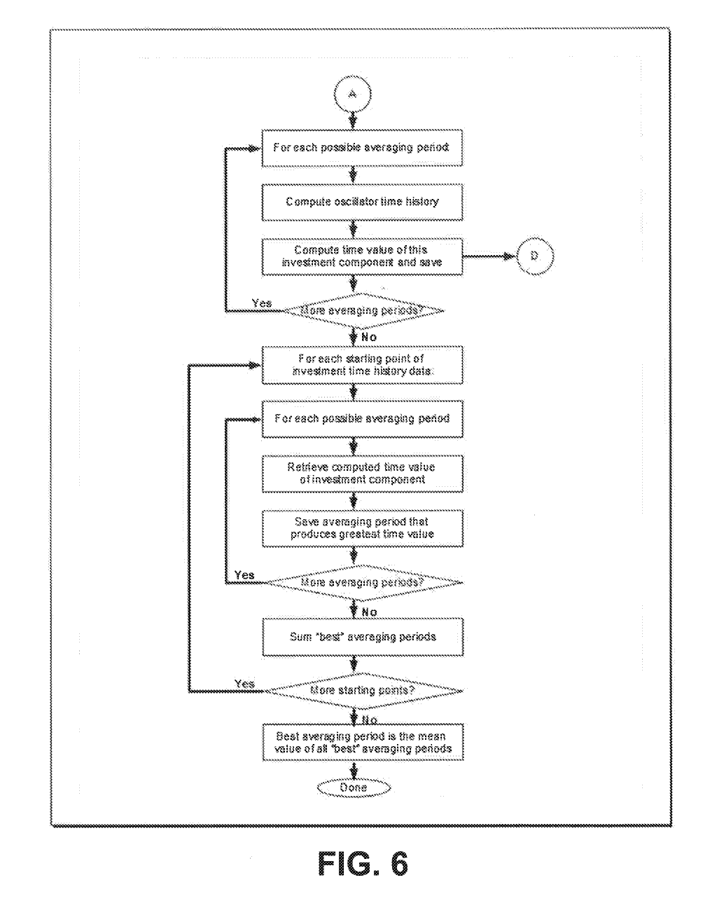

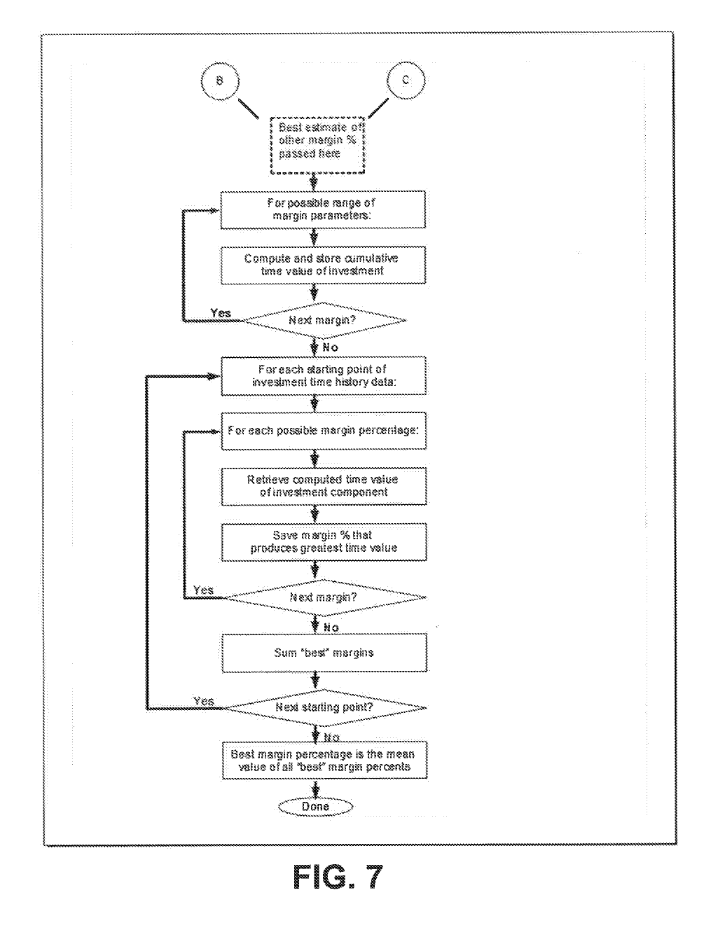

Steps in accordance with one or more computer-implemented methods may proceed according to the flow diagrams shown in FIGS. 2-7 and may include one or more of the following: A portfolio of investments is defined; investment total return time history data is gathered for each investment component for input into market timing method; minimum and maximum percentage allocation limits may be defined for each investment component; strategies (i.e., strategy pairs) such as Long/Long, Long/T-Bills (or cash equivalent), Long/Short, Long on Margin/T-Bills (or cash), Long on Margin/Short on Margin, T-Bills (or cash)/Short, T-Bills (or cash)/Short on Margin are selected to apply to each investment component; a timing oscillator is selected; other input parameters may be selected, such as Selected Strategy (i.e., strategy pair) for each investment component, Return Type for Optimum Investment Component Allocation (Compound Average or Arithmetic Average), Initial Investment amount, Analysis Start Month and Year, Long Maintenance Margin (%), Short Maintenance Margin (%), Margin Limit (%), Borrowing Cost Premium over T-Bill Rate(%), Margin Rate Premium over T-Bill Rate (%), Transaction Costs for Each Trade (%), Transaction Costs for Each Trade, Fixed Amount, Transaction Tax Rate (%), Minimum Oscillator Averaging Period, Analysis Required Minimum Return (%), Simulated Data Start Month and Year, beginning, Simulated Data End Month and End of Year; The Oscillator Averaging Period may then be optimized for each Investment Component (See, for example, FIGS. 4, 5 and 6); Oscillator time history is computed for each Investment Component (See, for example, FIG. 5); Long Margin Percentages may be optimized for each Investment Component (See, for example, FIGS. 5 and 7); Short Margin Percentages are optimized for each Investment Component (See, for example, FIGS. 5 and 7); market-timing modified time histories of total return for each Investment Component are calculated (These are the historical performance results of using the left half of the strategy pair when the contemporaneous value of the oscillator is positive and the right half when it is negative.) (See, for example, FIGS. 3 and 4); modified time histories may then be input into classic Modern Portfolio Theory; allocation results may be read from Modem Portfolio Theory computations; allocations are altered or modified based upon the current value of oscillator to proper portion of strategy for the respective investment component or asset class (e.g., if oscillator is positive, use the left half of the strategy; if negative, use the right half); and results are formatted for presentation to a user.

In certain preferred embodiments, the preceding steps are executed sequentially in the order listed. In particular, the portfolio components must first be defined (Step 1).Then the total return time histories can be obtained (Step 2). Next, the input parameters are selected (Steps 3-6) and then the computations of steps 7-11 can be performed. Step 12 determines the initial portfolio allocations and Step 13 alters them based on the current oscillator value and desired strategy. The data is presented in Step 14.

By following the listed steps in the stated order the method produces overall investment asset allocation recommendations superior to those of classic Modem Portfolio Theory. That is, the investor will avoid the bulk of losses during market downturns thus producing an increased overall portfolio return at lower risk. As illustrated in the case studies discussed in the last portion of this disclosure, the methods and systems of the present invention are effective in large part because significant market downturns tend to be long lasting in duration such that they can be identified early in their formation and avoided.

The use of margin is optional in implementing the method. The various strategy pairs are typically designated by a user or the computer system, but at least one strategy pair must be designated and used for each Investment Component. In particular, the long/T-bills strategy may be most practicable for the individual investor. The implementation of a timing oscillator is required, but the choice of which oscillator to use may be optional. Consideration of transaction costs, tax consequences, and other input parameters including simulated data limits and limits on allocations and averaging periods may also be optional. Incorporation of Modern Portfolio Theory and its associated input requirements are typically assumed and their mathematical mechanisms are conventionally known.

In particular preferred embodiments, computer coding of the described method and implementation of the resultant software in computer hardware is required to make the invention. In operation, the user would use a computer programmed to perform the method. This may require an internet connection to receive reports, access software, and/or use data made available (e.g., total return time history data for particular investment components) to perform the operations described in the steps. FIG. 1 illustrates one embodiment of the general system hardware which may be relied upon or incorporated in preferred embodiments of the present invention.

Notably, it is envisioned that aspects of this market-timing modification to Modem Portfolio Theory may be applied to many other applications where Modem Portfolio Theory is used, such as insurance, process control, search engine optimization, social psychology, and information retrieval.

FIG. 1a illustrates an exemplary computer-implemented method 100 in accordance with embodiments of the present invention. At block 102, the characterization of a portfolio of investment components is typically obtained, for example, from a user by way of the user's computing device. Each such investment component may be defined at least in part as a discreet portion of the overall value of the portfolio. At block 104, total return time history data for each investment component is stored. Such storage may take place, for example, in a memory location of the user's computing device.

At block 106, a collection of strategy pairs may be provided and, in certain preferred embodiments, may be selectable by the user. Each such strategy pair may be defined by respective first and second allocation alternatives (e.g., long/long, long/T-bills, long/short, T-bills/short on margin, etc.). At block 108, a designation of at least a respective one of the strategy pairs for each investment component may be received (e.g. from the user, or chosen by a computer-implemented sub-method based on optimization of portfolio risk reduction versus target return).

At block 110, a respective timing oscillator is implemented for each of the investment components. Such time oscillator may, for example, be selected from the group consisting of the Commodity Channel Index (CCI), Rate of Change (ROC) and Moving Average Convergence/Divergence (MACD). In particular preferred embodiments, the implemented time oscillator is the same for all of the investment components. At block 112, an oscillator time history is computed for each investment component by way of the respective timing oscillator. In particular preferred embodiments, this step of computing may be performed by the computing device of the user.

At block 114, modified time histories of total return are calculated for each investment component. In particular preferred embodiments, each modified time history may consist substantially of: (a) for sub-periods within which the value of the respective said timing oscillator was positive, historical performance results obtained using the first allocation alternative of the respective strategy pair, and (b) for sub-periods within which the value of the respective said timing oscillator was negative, historical performance results obtained using the second allocation alternative of the respective strategy pair. Depending upon the particular embodiment, for a sub-period within which the time oscillator value is zero, each modified time history may consist of historical performance results obtained using either the first or second allocation alternative of the respective strategy pair.

At block 116, allocations for the portfolio may be derived by inputting the modified time histories into, for example, an algorithm which is based upon classic modern portfolio theory. At block 118, these allocations are typically modified based upon a current value of the respective timing oscillator such that for each investment component: (i) if the respective timing oscillator is currently positive, the respective first allocation alternative is used, and (ii) if the respective timing oscillator is currently negative, the respective said second allocation alternative is used. At block 120, the modified allocations are typically formatted for presentation to a user on a computer display.

In certain embodiments of a computer-implemented method 100, in at least one of the collection of strategy pairs, the second allocation alternative is lower risk than its respective first allocation alternative (for example, the strategy pair of long/T-bills as it relates to a small-cap stock investment component).

In particular embodiments, at least one of the first allocation alternatives is selected from the group consisting of long, long on margin, and T-bills; and at least one of the second allocation alternatives is selected from the group consisting of long, T-bills, short, and short on margin. In certain embodiments, each investment component is further defined by a distinct asset class. Alternatively, users may characterize a portfolio in which multiple investment components are part of the same general asset class (e.g., large-cap stocks). In certain embodiments, at least one asset class may include assets selected from the group consisting of large-cap U.S. stocks, small-cap U.S. stocks, long-term investment-grade corporate bonds, long-term treasury bonds, intermediate-term treasury bonds, 30-day U.S. treasury bills, real estate investment trusts, international stocks, and international bonds.

A computer implemented method 100 may further include the addition sub-process of optimizing an oscillator averaging period for each investment component, wherein the step 112 of computing an oscillator time history for each said investment component is performed using respective optimized oscillator averaging periods. In certain such embodiments, the method may further include, prior to the step of calculating: optimizing a long margin percentage for any said investment component designated a respective said strategy pair having a long on margin allocation alternative; and optimizing a short margin percentage for any said investment component designated a respective said strategy pair having a short on margin allocation alternative.

The method of particular embodiments may further allow the user to select one or more input parameters from the following: return type, long maintenance margin, short maintenance margin, margin limit, borrowing cost premium over T-bill rate, margin rate premium over T-bill rate, transaction costs per trade, transaction tax rate, minimum oscillator averaging period, and analysis required minimum return. In certain such embodiments, the return type may be selectable as either an arithmetic or a geometric required return.

Certain preferred embodiments of the computer implemented method 100 may further comprise: allowing the user to input a target rate of return; performing, for each investment component, the steps of receiving, implementing, computing and calculating using each strategy pair of said collection prior to the step of modifying; and identifying, for each of the investment components and based upon the step of performing, which strategy pair of the collection produces the lowest overall risk while achieving the target return; wherein the step of modifying uses each of the identified strategy pairs for their respective investment component.

Certain embodiments may substantially consist of a non-transitory computer-readable storage medium encoded with a computer program, wherein execution of the computer program by one or more processors causes the one or more processors to perform one or more of the computer-implemented methods described herein. Moreover, referring to FIG. 1b, in certain such embodiments the storage medium may comprise at least a first memory device of a web server (e.g., internet resident server) and a second memory device of a computing device of the user (e.g., such memory being contained within one of the user computing devices depicted in FIG. 1b).

In particular embodiments of the non-transitory computer-readable storage medium the method may further comprise, prior to the step of calculating: optimizing an oscillator averaging period for each investment component; optimizing a long margin percentage for any investment component designated a respective strategy pair having a long on margin allocation alternative; and optimizing a short margin percentage for any investment component designated a respective strategy pair having a short on margin allocation alternative; wherein the step of computing an oscillator time history for each said investment component is performed using respective said optimized oscillator averaging periods.

Certain embodiments may substantially consist of a computer system for facilitating management of asset portfolios, comprising one or more memory devices and one or more processors (e.g., a processor in a user computing device and a processors in a remote server). Each such processor may preferably be in communication with at least a respective one of the memory devices. In preferred system embodiments, the processors may be collectively configured to perform one or more of the computer-implemented methods described herein.

### Historical Back-Testing of Preferred Embodiments

Certain preferred methods in accordance with the present invention substantially incorporate what may in some cases be referred to herein as the “modified modern portfolio theory model,” or MMPT model. However, without computer implementation, performance or use of such model would be likely be impractical or ineffective, particularly for facilitating management of large or complex asset portfolios. The following sections compare the performance of a portfolio constructed with the allocations generated using embodiments of the present invention with the performance of the classic MPT model designed to achieve the same return over three periods of market correction: the extended flat market between 1965 to 1975, the bursting of the dot-com bubble from 2000-2002, the sub-prime mortgage crisis of 2007-2009.

Before delving into the case studies, a word on how the model portfolios are constructed is in order. Both the classic MPT and MMPT portfolios used in testing were composed of the same nine asset classes (listed below) most widely used in traditionally allocated portfolios.

Large-cap U.S. Stocks (S&P 500)

Small-cap U.S. Stocks (Russell 2000)

Long-Term investment-grade Corporate Bonds

Long-Term Treasury Bonds

Intermediate-Term Treasury Bonds

30-day U.S. Treasury Bills (or a safe cash-equivalent)

Real Estate Investment Trusts (REITs)

International Stocks

International Bonds

A required compounded annual total return of 10% was selected for testing being that it is neither too conservative nor too speculative. Both portfolios are rebalanced following updated allocation recommendations provided each month using the same database of historical monthly returns for each asset class. Current portfolio allocations are derived using monthly total return data for each asset class dating back to January of 1928.

Case Study #1: 1965-1975: Extended Flat Market

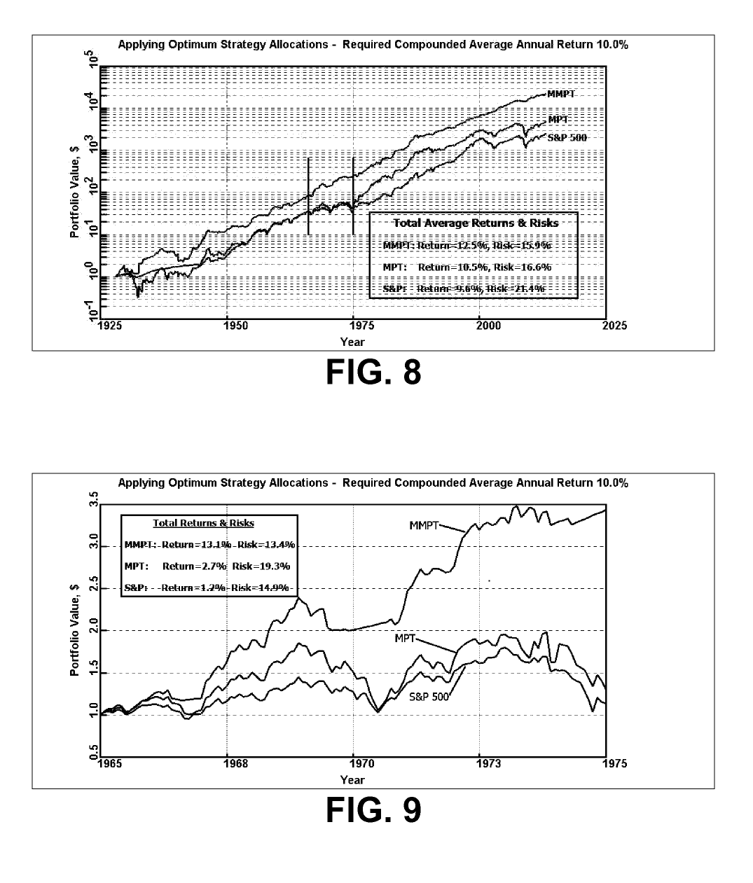

There are periods in history when entering the market hasn't been providential. The period from 1965 to 1975 was one of those times when a classically constructed MPT portfolio initiated in 1965 would essentially be in the same place ten years later. Referring to FIG. 8, returns are shown for both the classic MPT portfolio and the S&P 500 remained flat for a decade despite two rallies in the interim. Also shown is the return profile of the MMPT portfolio. (The returns for each model along with its associated risk (σ) during the entire time period (1928—present) are shown in the embedded window label.)

FIG. 9 details the same portfolio returns over the time-frame of interest (January 1965 through December 1974) on a linear scale. During this time frame, the S&P 500 barely provided a positive return (1.2%) while the MPT portfolio only did slightly better (2.7%). On the other hand, not only did the MMPT portfolio achieve its 10% required annual compounded return, but it handily beat it (13.4%). Moreover, it accomplished it at a risk level lower than both of the others. Certainly one can construct a time frame that works for any model. However, as can be seen in FIG. 8, a long-term investment horizon has the advantage over a short-term one. One problem is that a portfolio can be initiated at any time regardless of market conditions. How that portfolio is able to respond to changing market conditions is critical. In this sense, let's look at two recent periods of extreme market volatility.

2000—February 2013: A Period of Market Turbulence

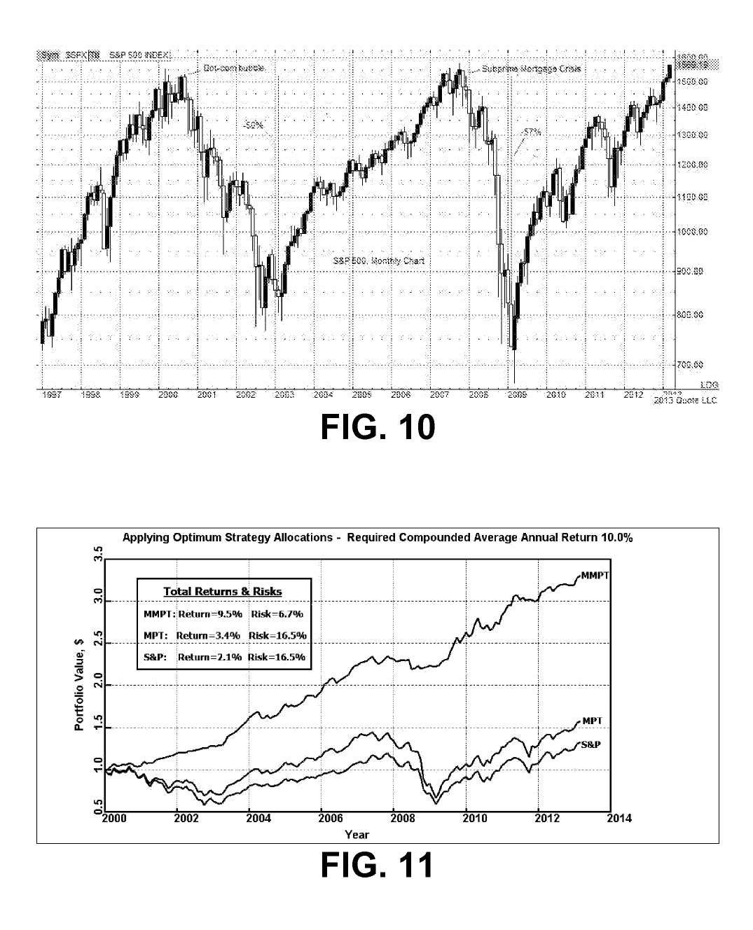

The chart of the S&P 500 shown in FIG. 10 illustrates how much of an impact the market corrections in the last decade or so have had on portfolios. During the 2000-2002 bursting of the dot-com bubble, the index lost 50% of its value. As devastating as that was, it wasn't nearly as bad as the 57% drop from 2007 to 2009 resulting from the sub-prime mortgage crisis.

Comparison of Results for the Entire Time Period (2000—February 2013)

Referring now to FIG. 11, total returns for both the MPT and MMPT models are plotted along with the total return of the S&P 500 from January of 2000 to February of 2013. The results show an astounding difference in both return and risk (as measured by the standard deviation of returns about the mean). Because of under-performance in nearly every asset class during this time, the MMPT portfolio was only able to return 9.5% instead of the required 10%. However, it handily beat the classic MPT model which could only return a paltry 3.4%—not very good but still better than the 2.1% return of the S&P 500. It should be noted that the MMPT return is not only significantly higher, but it was achieved at substantially lower risk (6.7% vs. 16.5% for both the MPT model and the S&P 500).

Notably, even from the beginning of the market's decline in 2000, the MMPT portfolio return was always positive—not so for the classic MPT model nor the benchmark S&P 500. It took nearly five years for the classic portfolio to break even and almost seven years for the S&P 500 to do so. Moreover, following the 2007 mortgage crisis, it took another five years for both the classic portfolio and the S&P 500 to climb back to their pre-crash values. However, this crisis was but a mere pause in the increasingly positive returns for the MMPT portfolio. Finally, during this time, not only was the return on the MMPT portfolio superior to both the classic model and the S&P 500, but this superior performance was achieved at a greatly reduced risk. This fact alone should be of interest to fund managers and investors alike.

The next two case studies provide an in-depth look as to how implementation of the MMPT was able to out-perform the classic MPT model and the S&P 500.

Case Study #2: The Dot-Com Bust (2000-2002)

The bursting of the dot-com bubble is chosen as a period for back-testing because it was the first severe market decline in recent history that most people will remember, though many may not remember it fondly. Investors who were heavily invested in internet-based equities leading up to the dot-com bust experienced unprecedented returns but saw their gains rapidly erode following the mid-2000 market peak. But that wasn't nearly as tragic as those who began investing at the peak of the bubble. They had to wait seven years just to regain their initial investment. From the Sep. 1, 2000 peak to the Oct. 10, 2002 trough, the S&P 500 lost nearly 50% of its value but that was nothing compared with the 78% loss in the tech-heavy Nasdaq. Portfolios heavily weighted in tech got clobbered.

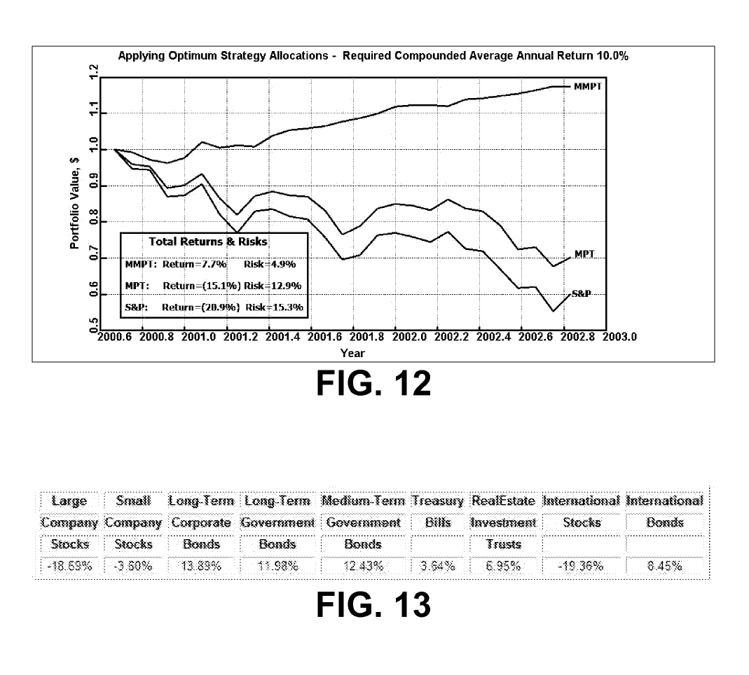

FIG. 12 provides a chart which compares the total returns between an MMPT portfolio and the corresponding MPT portfolio compared to the S&P 500. Please note that the returns cited in these figures are annualized returns. This chart shows that the MPT portfolio and the S&P 500 both declined significantly during the dot-com bust (−15.1% and −20.9%, respectively). On the other hand, the MMPT portfolio was not only able to stay out of the red, but it was able to achieve a 7.7% annualized return realized at much lower risk.

To understand why the classic MPT portfolio under-performed and why the MMPT model was able to provide a decent positive return during this time-frame, we first need to look at the performance of the underlying asset classes.

FIG. 13 provides a table which shows that the annualized total returns for all asset classes except for bonds fared poorly during this time period (2000-2003). Large-cap stocks and international stocks suffered the most. With these returns in mind, we will see how classically allocated MPT portfolio would have kept the investor in these poorly performing asset classes.

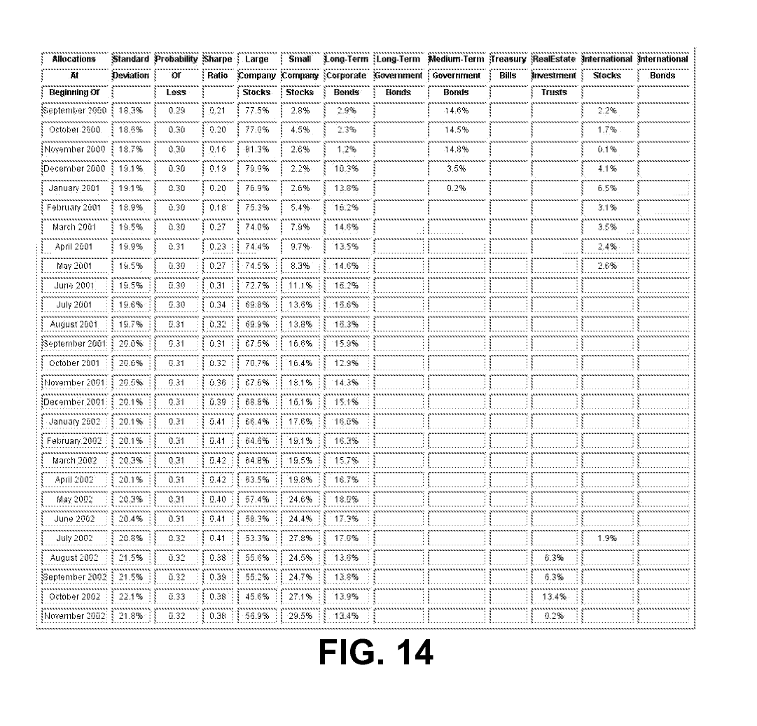

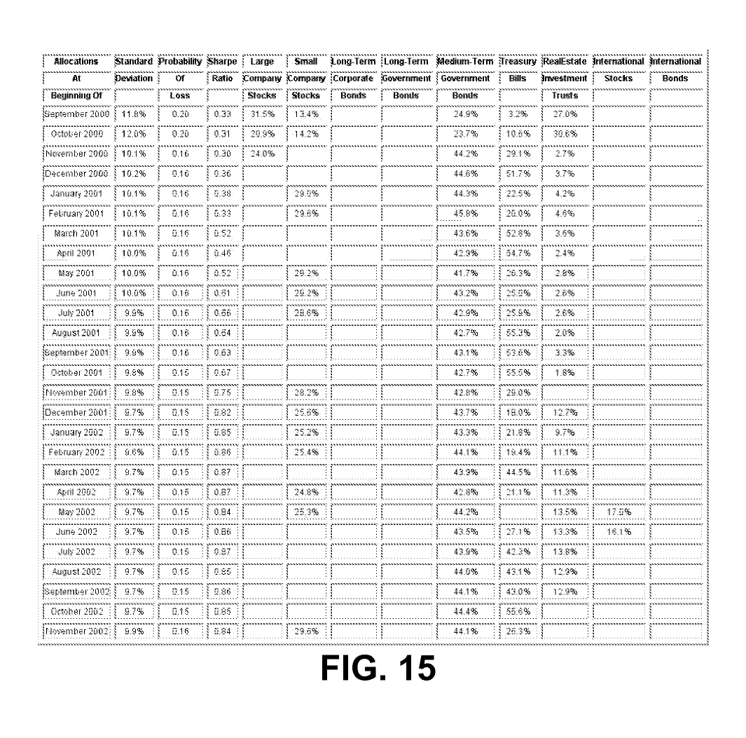

FIG. 14 illustrates that classic MPT allocations during the dot-com bust for a targeted 10% compounded annual return. As shown, at the onset of the dot-com bubble, the classically allocated MPT portfolio would have been heavily invested in large-cap stocks with the remaining funds chiefly in intermediate term government bonds. MPT was very slow to respond to the decline in the value of large-cap stocks. This was the main reason for the decline in portfolio value. Contrastingly, FIG. 15 illustrates the modified allocation produced by the MMPT equivalent model (for same time period and target return). As shown, implementation of the MMPT model would have taken investors out of both large-cap and small-cap stocks as well as real-estate investment trusts—the other major portfolio investment—as early as November of 2000. Also as shown, the proceeds from the sale of these asset classes were then moved into the safety of intermediate-term government bonds and T-bills. This move was triggered by the shift in the timing oscillator for each of the above-mentioned asset classes from positive to negative.

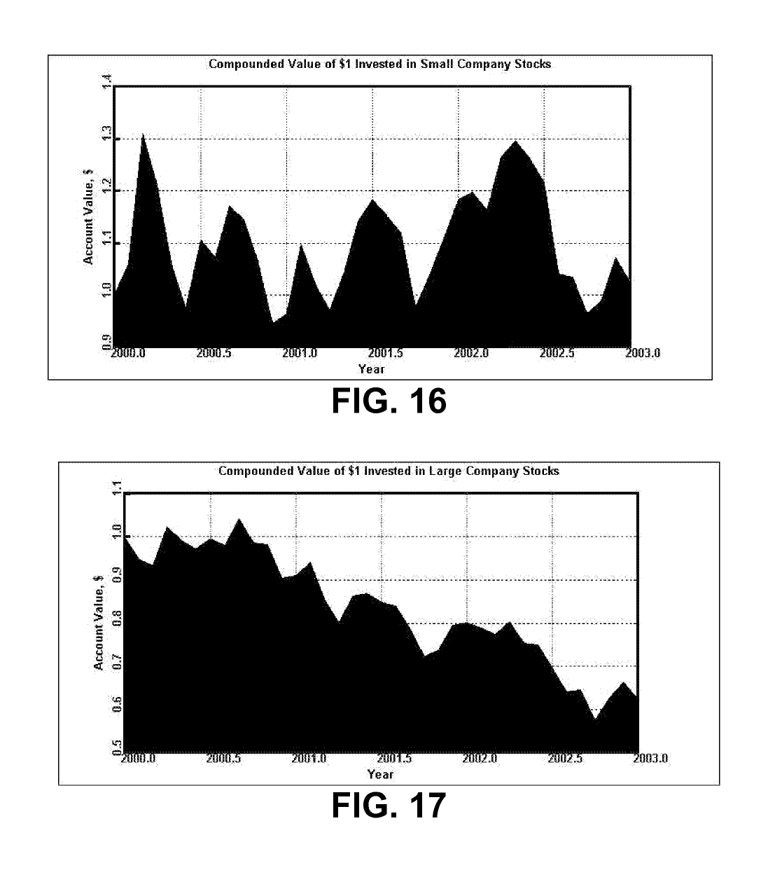

The table in FIG. 15 shows that for some of the time during the dot-com bust there was an on and off movement into and out of small-caps. This seemingly fickle behavior by the MMPT model can be understood when looking at the total return chart for small-cap stocks at the time (see FIG. 16). Notably, while the large-cap asset class was collapsing (see FIG. 17), the small-caps actually hung in there despite fluctuations in value. It is interesting to note that out of all of the asset classes, corporate bonds fared the best but MMPT did not allocate funds to them, instead preferring the lower volatility and risk of intermediate-term government bonds. It is important to note that in the particular MMPT model presented here, the oscillator strategy only applies to non-fixed income asset classes. Bonds are treated just as they are in classic MPT since they are less volatile by nature compared with stocks. (Note that in applications' Portfolio Preserver® software platform embodiment of the present invention, a market-timing oscillator can be applied to any asset class, if desired.)

Case Study #3: The Sub-Prime Mortgage Crisis (2007-2009)

Let's now look at something that wreaked even more havoc on portfolio returns than the dot-com bust—the sub-prime mortgage crisis from October, 2007 through March, 2009. Back-testing showed that an MMPT based portfolio again produces superior returns and at much lower risk than its classic MPT based counterpart.

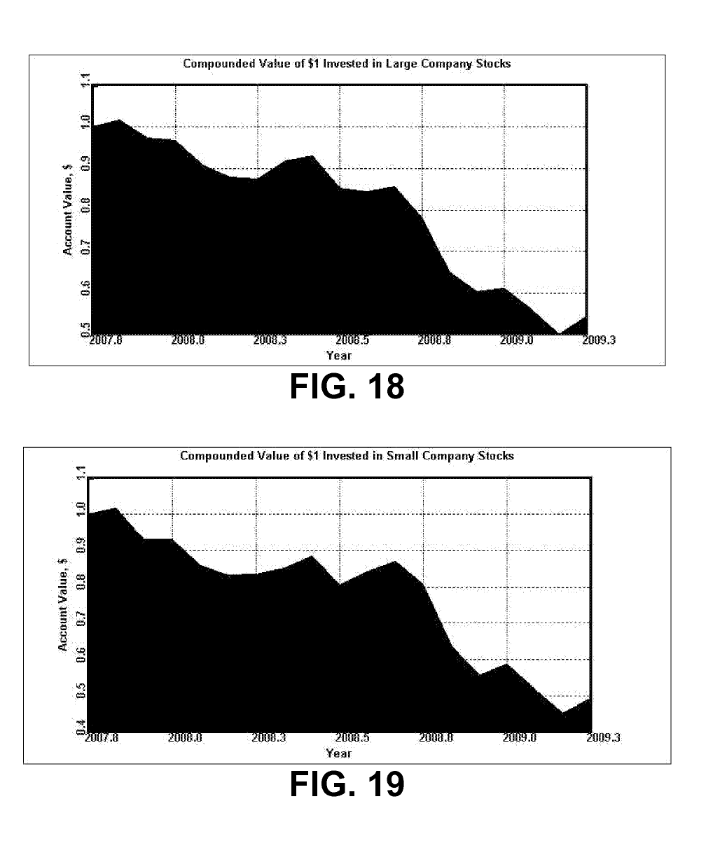

The time frame used in this analysis begins on Oct. 11, 2007 when the S&P 500 hit an intraday high of 1576 and ends on Mar. 6, 2009 when the S&P 500 reached an intraday low of 667. This represents a loss of over 57%, more than the 50% loss suffered during the dot-com bust. FIG. 18 pictorially represents the sharp decline in the S&P 500 during this time. Note that total return data shown in FIG. 18 includes dividends. The mortgage crisis took an even bigger bite out of small-cap stocks (see FIG. 19). This was not the case in the dot-com bust where the value of small-cap stocks actually hung in there despite price fluctuations (refer to FIG. 16 above).

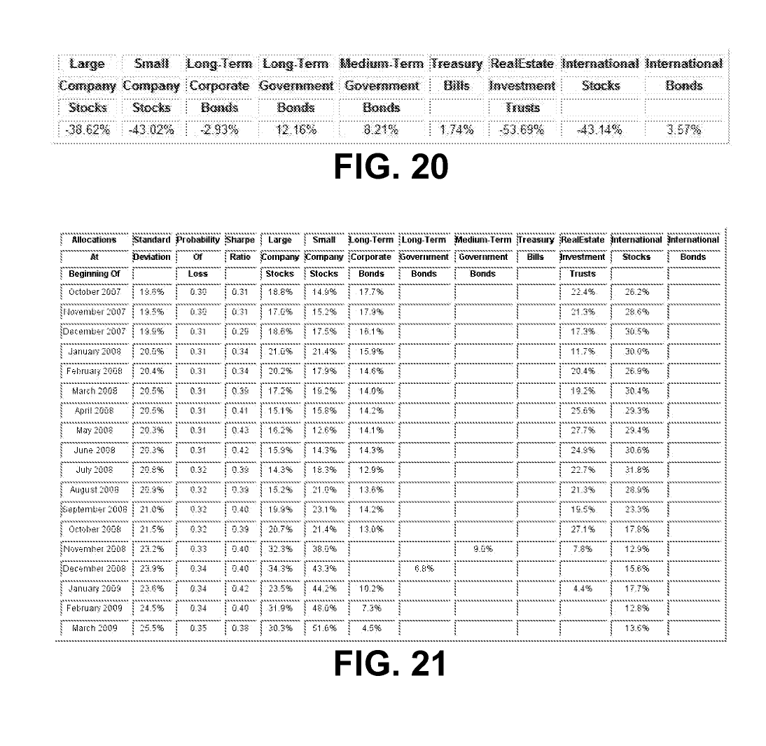

The table in FIG. 20 shows that the annualized returns for all asset classes except for government bonds did poorly between 2007 and 2009. Comparing these returns with those during the dot-com bust in the table of FIG. 13, we can see that each of the asset classes except for government bonds fared much worse during the sub-prime crisis. Not surprising, the hardest hit were REITs which swung from a +7% return during the dot-com bust to a whopping −54% loss during the mortgage crisis. The table in FIG. 21 shows that, for a targeted 10% compounded annual return, a classic MPT portfolio would have had roughly 60-80% of their assets allocated to equities with the rest divided between REITs and corporate bonds—exactly all of the worst performing asset classes during this period.

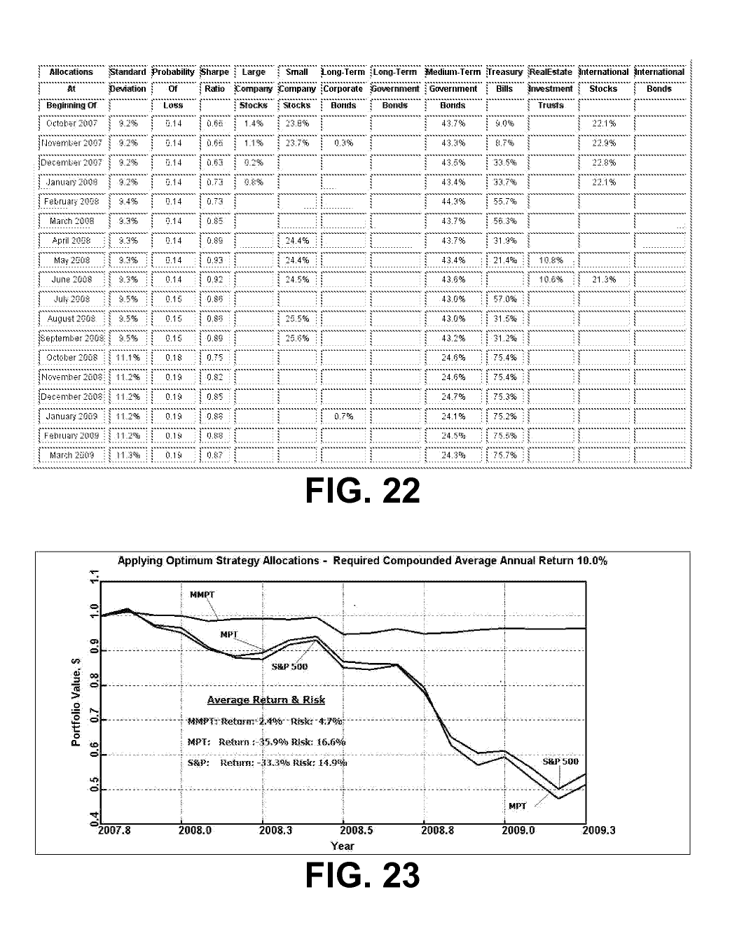

By comparison, referring now to FIG. 22, the MMPT equivalent portfolio (for same time period, same target return) was already light in large-cap stocks, having benefited from the experience of the collapse of the dot-com bubble. For the entire period of the sub-prime meltdown, the MMPT portfolio was heavily weighted (70-100%) in medium-term government bonds and T-bills, with some minor exposure to small-caps and international equities. Referring again to FIG. 20, it was this exposure to the equity classes that caused the most harm to both portfolios. It is interesting to note that long-term government bonds fared the best in a so-called flight to safety but MMPT did not allocate funds to it instead preferring the historical lower volatility of intermediate-term bonds.

Referring now to FIG. 23, we compare the respective portfolio returns during the months of the sub-prime mortgage crisis. As shown, during this period, the S&P 500 lost money at an annualized rate of 33.3%. As bad as this was, the classic MPT portfolio performed even worse losing nearly 36%. Compare the devastation wreaked by both of these to the mild 2.4% dip experienced by the MMPT portfolio. Moreover, there was markedly less volatility associated with the MMPT portfolio (4.7% vs 16.65%). This was because the MMPT portfolio was comprised of asset classes (mainly bonds) of lower volatility. The reason that the MMPT portfolio wasn't able to do better was because of the extreme under-performance of most of the component asset classes as well as due to the mandate of risk minimization.

Summary of MMPT Performance During Market Corrections

The above case studies show that a portfolio constructed using implementations of the MMPT approach not only protects the investor during periods of market under-performance but it does so at a much lower risk than its MPT counterpart and the benchmark index. This is an important added benefit of the MMPT model—it reduces risk without the need for hedging or other costly risk-reduction techniques such as buying put options. In essence, the MMPT model acts as its own hedge.

As superior as MMPT is to MPT, returns using either model are inherently limited by the performance of the underlying asset classes. Historically, stocks and bonds have been generally negatively correlated to each other meaning that if stocks moved higher, bonds moved lower, and vice-versa. Many commodities, too, were either negatively correlated or completely uncorrelated with other asset classes. A portfolio constructed using a selection of asset classes with varying correlations should be able to provide robust returns at lower risk over most market scenarios.

Lately, all of this has changed. Stocks, bonds, and commodities are becoming increasingly correlated as national economies become more interdependent. For this reason alone, it is even more important to apply a market-timing approach to prevent major portfolio loss, the reason being that a judiciously and properly applied market timing approach to the standard MPT model injects an element of nimbleness and reactivity while still benefiting from historical experience. This is of tremendous value especially in today's volatile markets. Through these case studies we have back-tested and demonstrated the superiority of the MMPT approach over the classic MPT model in both risk-reduction and portfolio preservation over market downturns ranging from mild to severe.

Preferred implementations of the MMPT model offer the investment manager greater flexibility in terms of portfolio construction and investment philosophy compared with classic MPT. Advantages of the MMPT approach may include the following:
(a) A portfolio only needs to be re-balanced at most once per month to achieve the superior return/risk results published here. This efficiency of time frees up the investment manager to do other things.
(b) Any asset class (other than the traditional ones listed) can be easily added or removed, thus providing a mechanism for complete portfolio customization.
(c) While this disclosure specifically addresses portfolios that are comprised of either being long an asset class or in cash (depending on the value of the oscillator for that asset class), the market-timing approach of the MMPT model allows the manager to short an asset class, if so desired. In this way, the manager has more investing options and during times of severe market corrections, he or she may even be able to generate superior returns by taking the short side. For example, taking the short side in stocks and REITs for intermittent periods during the sub-prime crisis could have generated a significant positive total return (see FIG. 20, for example). This option is not available in the classic MPT model.
(d) The fact that MMPT is a purely quantitative model removes human bias and eliminates guessing as to when to enter and exit an asset class for those who use embodiments of the present invention. It also provides for a high level of transparency.
(e) The MMPT model is self-hedging, meaning that costly external hedging mechanisms are not required to reduce risk.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A computer implemented method for managing asset portfolios, said method comprising:
obtaining the characterization of a portfolio of investment components, wherein each said investment component is defined at least in part as a discreet portion of the overall value of said portfolio;
storing total return time history data for each said investment component;
providing a collection of strategy pairs, each said strategy pair being defined by respective first and second allocation alternatives;
receiving a designation of at least a respective one of said strategy pairs for each said investment component;
implementing a respective timing oscillator for each said investment component;
computing an oscillator time history for each said investment component by way of their respective said timing oscillator;
calculating modified time histories of total return for each said investment component, wherein each said modified time history consists substantially of
(a) for sub-periods within which the value of the respective said timing oscillator was positive, historical performance results obtained using said first allocation alternative of the respective strategy pair, and
(b) for sub-periods within which the value of the respective said timing oscillator was negative, historical performance results obtained using said second allocation alternative of the respective strategy pair;
deriving allocations for said portfolio by inputting said modified time histories into an algorithm which is based upon classic modern portfolio theory;
modifying said allocations based upon a current value of the respective said timing oscillator such that for each said investment component:
(i) if the respective timing oscillator is currently positive, the respective said first allocation alternative is used, and
(ii) if the respective timing oscillator is currently negative, the respective said second allocation alternative is used; and
formatting said modified allocations for presentation thereof to a user on a computer display.

2. A computer implemented method as defined in claim 1 wherein, in at least one of said collection of strategy pairs, said second allocation alternative is lower risk than its respective said first allocation alternative.

3. A computer implemented method as defined in claim 1 wherein:
at least one said first allocation alternative is selected from the group consisting of long, long on margin, and T-bills; and
at least one said second allocation alternative is selected from the group consisting of long, T-bills, short, and short on margin.

4. A computer implemented method as defined in claim 1, wherein each said investment component is further defined by a distinct asset class.

5. A computer implemented method as defined in claim 4, wherein at least one said asset class includes assets selected from the group consisting of large-cap U.S. stocks, small-cap U.S. stocks, long-term investment-grade corporate bonds, long-term treasury bonds, intermediate-term treasury bonds, 30-day U.S. treasury bills, real estate investment trusts, international stocks, and international bonds.

6. A computer implemented method as defined in claim 1, wherein said implemented time oscillator is the same for all said investment components.

7. A computer implemented method as defined in claim 6, wherein said implemented time oscillator is selected from the group consisting of the Commodity Channel Index (CCI), Rate of Change (ROC) and Moving Average Convergence/Divergence (MACD).

8. A computer implemented method as defined in claim 1, wherein said characterization is obtained from said user.

9. A computer implemented method as defined in claim 1, wherein said designation is received from said user.

10. A computer implemented method as defined in claim 1, wherein said step of computing is performed by a computing device of said user.

11. A computer implemented method as defined in claim 1, further including:
optimizing an oscillator averaging period for each said investment component;
wherein said step of computing an oscillator time history for each said investment component is performed using respective said optimized oscillator averaging periods.

12. A computer implemented method as defined in claim 11, further including, prior to the step of calculating:
optimizing a long margin percentage for any said investment component designated a respective said strategy pair having a long on margin allocation alternative; and
optimizing a short margin percentage for any said investment component designated a respective said strategy pair having a short on margin allocation alternative.

13. A computer implemented method as defined in claim 1, further including:
allowing said user to select one or more input parameters from the group consisting of return type, long maintenance margin, short maintenance margin, margin limit, borrowing cost premium over rate, margin rate premium over rate, transaction costs per trade, transaction tax rate, minimum oscillator averaging period, and analysis required minimum return.

14. A computer implemented method as defined in claim 13, wherein said return type is selectable being as either an arithmetic or a geometric required return.

15. A non-transitory computer-readable storage medium encoded with a computer program, wherein execution of said computer program by one or more processors causes said one or more processors to perform the method of claim 1.

16. The non-transitory computer-readable storage medium of claim 15 wherein said storage medium comprises at least a first memory device of a web server and a second memory device of a computing device of said user.

17. A computer system for facilitating management of asset portfolios, comprising:
one or more memory devices;
one or more processors, each processor being in communication with at least a respective said memory device, said processors collectively being configured to:
obtain the characterization of a portfolio of investment components, wherein each said investment component is defined at least in part as a discreet portion of the overall value of said portfolio;
store total return time history data for each said investment component;
provide a collection of strategy pairs, each said strategy pair being defined by respective first and second allocation alternatives;
receive a designation of at least a respective one of said strategy pairs for each said investment component;
implement a respective timing oscillator for each said investment component;
compute an oscillator time history for each said investment component by way of their respective said timing oscillator;
calculate modified time histories of total return for each said investment component, wherein each said modified time history consists substantially of
(a) for sub-periods within which the value of said timing oscillator was positive, historical performance results obtained using said first allocation alternative of the respective strategy pair, and
(b) for sub-periods within which the value of said timing oscillator was negative, historical performance results obtained using said second allocation alternative of the respective strategy pair;
derive allocations for said portfolio by inputting said modified time histories into an algorithm which is based upon classic modern portfolio theory;
modify said allocations based upon a current value of the respective said timing oscillator such that for each said investment component:
(i) if said timing oscillator is currently positive, the respective said first allocation alternative is used, and
(ii) if said timing oscillator is currently negative, the respective said second allocation alternative is used; and
format said modified allocation for presentation to a user on a computer display.

18. A non-transitory computer-readable storage medium encoded with a computer program for facilitating management of asset portfolios, wherein execution of said computer program by one or more processors causes said one or more processors to perform a method, said method comprising:
obtaining, from a user, the characterization of a portfolio of investment components, wherein each said investment component is defined at least in part as a discreet portion of the overall value of said portfolio;
storing total return time history data for each said investment component;
providing a collection of strategy pairs, each said strategy pair being defined by respective first and second allocation alternatives, wherein:
in at least one said strategy pair, said second allocation alternative is lower risk than its respective said first allocation alternative;
at least one said first allocation alternative is selected from the group consisting of long, long on margin, and T-bills; and
at least one said second allocation alternative is selected from the group consisting of long, short, and short on margin.
receiving a designation of at least a respective one of said strategy pairs for each said investment component;
implementing a timing oscillator for each said investment component;
computing an oscillator time history for each said investment component by way of said timing oscillator;
calculating modified time histories of total return for each said investment component, wherein each said modified time history consists substantially of:
(a) for sub-periods within which the value of the respective said timing oscillator was positive, historical performance results obtained using said first allocation alternative of the respective strategy pair, and
(b) for sub-periods within which the value of the respective said timing oscillator was negative, historical performance results obtained using said second allocation alternative of the respective strategy pair;
deriving allocations for said portfolio by inputting said modified time histories into an algorithm which is based upon classic modern portfolio theory;
modifying said allocations based upon a current value of the respective said timing oscillator such that for each said investment component:
(i) if the respective timing oscillator is currently positive, the respective said first allocation alternative is used, and
(ii) if the respective timing oscillator is currently negative,the respective said second allocation alternative is used; and
formatting said modified allocations for presentation to said user on a computer display.

19. The non-transitory computer-readable storage medium of claim 18, wherein said implemented time oscillator is the Commodity Channel Index (CCI).

20. The non-transitory computer-readable storage medium of claim 18, wherein said method further comprises, prior to the step of calculating:
optimizing an oscillator averaging period for each said investment component;
optimizing a long margin percentage for any said investment component designated a respective said strategy pair having a long on margin allocation alternative; and
optimizing a short margin percentage for any said investment component designated a respective said strategy pair having a short on margin allocation alternative;
wherein said step of computing an oscillator time history for each said investment component is performed using respective said optimized oscillator averaging periods.

21. The computer implemented method of claim 1., wherein said method further comprises:
allowing said user to input a target rate of return;
performing, for each said investment component, said steps of receiving, implementing, computing and calculating using each said strategy pair of said collection prior to said step of modifying; and
identifying, for each said investment component and based upon said step of performing, which said strategy pair of said collection produces the lowest overall risk while achieving the target return;
wherein said step of modifying uses said identified strategy pairs for their respective investment component.
